(19) United States
(12) Patent Application Publication
(10) Pub. No.: US 2019/0325340 A1
(43) Pub. Date: Oct. 24, 2019

(54) MACHINE LEARNING METHOD, MACHINE LEARNING DEVICE, AND COMPUTER-READABLE RECORDING MEDIUM

(71) Applicant: FUJITSU LIMITED, Kawasaki-shi (JP)

(72) Inventors: Izumi Nitta, Kawasaki (JP); Tatsuru Matsuo, Kawasaki (JP)

(73) Assignee: FUJITSU LIMITED, Kawasaki-shi (JP)

(21) Appl. No.: 16/366,737

(22) Filed: Mar. 27, 2019

(30) Foreign Application Priority Data
Apr. 20, 2018 (JP) 2018-081898

(51) Int. Cl. G06N 20/00; G06N 3/04; G06Q 10/10

(52) U.S. Cl. CPC G06N 20/00; G06Q 10/109; G06N 3/04

(57) ABSTRACT

A non-transitory computer-readable recording medium stores therein a machine learning program that causes a computer to execute a process including: generating pieces of learning data based on time series data including a plurality of items and including a plurality of records corresponding to a calendar, each of the pieces of learning data being learning data of a certain period, the certain period being composed of a plurality of unit periods, start times of the certain period of each of the pieces of learning data being different from each other for the unit period, in which each of the pieces of the learning data and a label corresponding to the start time are paired; generating, based on the generated learning data, tensor data in which a tensor is created with calendar information and the plurality of items having different dimensions; and performing deep learning of a neural network and learning of a method of tensor decomposition with respect to a learning model in which the tensor data is subjected to the tensor decomposition as input tensor data to be inputted to the neural network.

### CROSS-REFERENCE TO RELATED APPLICATION

This application is based upon and claims the benefit of priority of the prior Japanese Patent Application No. 2018-081898, filed on Apr. 20, 2018, the entire contents of which are incorporated herein by reference.

### FIELD

The embodiment discussed herein is related to a machine learning method, a machine learning device, and a computer-readable recording medium.

### BACKGROUND

Predicting mentally unwell conditions of employees in a few months later based on their attendance records data and taking some actions such as counseling in earlier stages to present them from taking a suspension of work (sick leave) has been performed. Generally, dedicated staff members perform a visual check to find an employee who falls on work conditions with feature patterns such as frequent business trips, long overtime, repeated sudden absences, absence without notice, and a combination of these patterns. It is difficult to clearly define these feature patterns, because such dedicated staff members may individually have their own standards. In recent years, machine learning using a decision tree, random forest, SVM (Support Vector Machine), or the like has been performed to learn feature patterns specific to mentally unwell conditions and to automatically provide a prediction, which has been decided by the dedicated staff members. Examples of related art are described in Japanese Laid-open Patent Publication No. 2007-156721 and Japanese Laid-open Patent Publication No. 2006-163521.

Machine learning, however, requests at least a certain number of pieces of learning data. Unwell persons account for about 2 to 3% of an organization, and thus it is difficult to collect a satisfactory number of pieces of data for learning. Accordingly, it is difficult to increase the accuracy of learning

For general machine learning, inputting a feature vector with a fixed length is a prerequisite. One simple vector representation method of attendance record is to arrange daily attendance status in chronological order. Learning data is generated vectorizing daily statuses in attendance record data in the order of arrows in the attendance record data. FIG. 14 is a diagram for explaining a data format of general machine learning. As illustrated in FIG. 14, for general machine learning, respective values set for elements, such as an attendance/absence status in June 1, a business trip status in June 1, attendance time information in June 1, leave time information in June 1, an attendance/absence status in June 2, a business trip status in June 2, attendance time information in June 2, and leave time information in June 2, are vectorized in this order.

In this manner, a data format of learning data simply provides vector information, but does not provide attribute information on each element of the vector. Accordingly, it is not possible to distinguish which value represents attendance/absence information or which value represents business trip information. Generating a plurality of pieces of learning data from an attendance record data does not always increase the number of feature patterns of an unwell person because the relations among the attributes are unclear. By contrast, a plurality of feature patterns are possibly provided to an unwell person. This causes overfitting and degrades the accuracy of learning.

### SUMMARY

According to an aspect of an embodiment, a non-transitory computer-readable recording medium stores therein a machine learning program that causes a computer to execute a process including: generating pieces of learning data based on time series data including a plurality of items and including a plurality of records corresponding to a calendar, each of the pieces of learning data being learning data of a certain period, the certain period being composed of a plurality of unit periods, start times of the certain period of each of the pieces of learning data being different from each other for the unit period, in which each of the pieces of the learning data and a label corresponding to the start time are paired; generating, based on the generated learning data, tensor data in which a tensor is created with calendar information and the plurality of items having different dimensions; and performing deep learning of a neural network and learning of a method of tensor decomposition with respect to a learning model in which the tensor data is subjected to the tensor decomposition as input tensor data to be inputted to the neural network.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining a whole example of machine learning according to a first embodiment;

FIG. 2 is a diagram exemplifying a relation between a graph structure and a tensor;

FIG. 3 is a diagram exemplifying extraction of a partial graph structure;

FIG. 4 is a diagram for explaining a learning example of Deep Tensor;

FIG. 5 is a functional block diagram illustrating a functional structure of a learning device according to the first embodiment;

FIG. 6 is a diagram illustrating an example of attendance record data stored in an attendance record data database (DB);

FIG. 7 is a diagram for explaining a generation example of learning data;

FIG. 8 is a diagram for explaining a specific example of creating a tensor;

FIG. 9 is a flowchart illustrating a flow of learning processes;

FIG. 10 is a diagram for explaining a problem in a case where a method of the first embodiment is applied to general machine learning;

FIG. 11 is a diagram for explaining an example of applying the method of the first embodiment to Deep Tensor;

FIG. 12 is a diagram for explaining the effect;

FIG. 13 is a diagram for explaining a hardware configuration example; and

FIG. 14 is a diagram for explaining a data format for general machine learning.

### DESCRIPTION OF EMBODIMENT(S)

Preferred embodiments will be explained with reference to accompanying drawings. This embodiment is, however, not intended to limit the scope of the present invention in any way. Moreover, it is possible to combine the embodiments one another as appropriate within a scope without inconsistency.

### [a] First Embodiment

### Whole Example

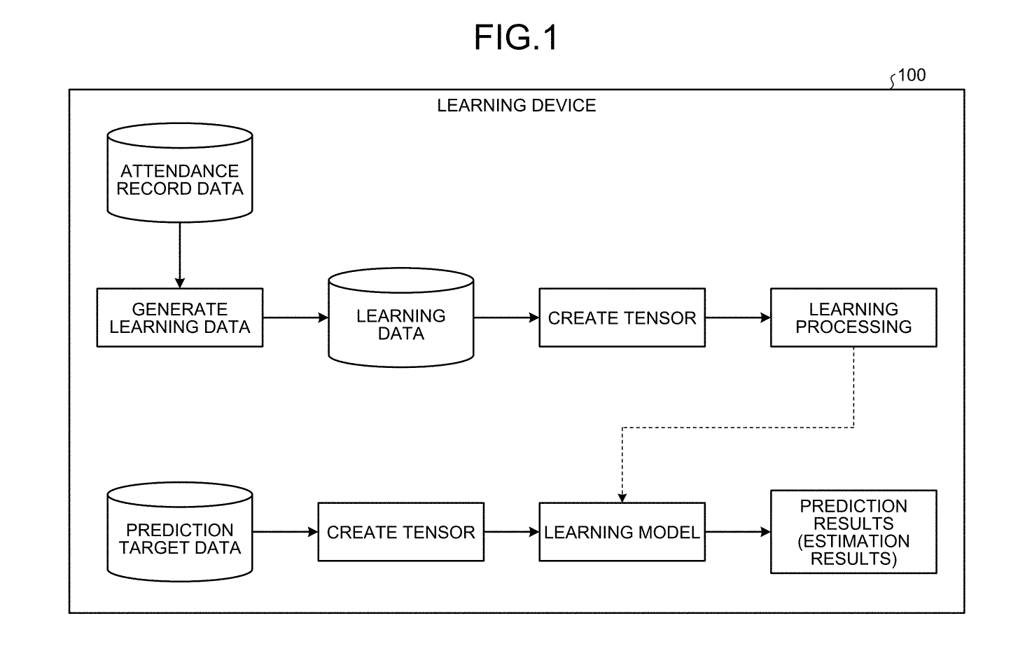

FIG. 1 is a diagram for explaining a whole example of machine learning according to a first embodiment. As illustrated in FIG. 1, a learning device 100 according to the first embodiment is an example of a machine learning device. The learning device 100 is an example of a computer device that generates a learning model through machine learning on attendance record data for employees including their daily statuses of attendance, attendance and leave times, taking a holiday, and a business trip, and using the learning model after learning, predicts whether a certain prediction target employee will take sick leave, from the attendance record data of that employee. Although the example that the learning device 100 executes both learning and prediction is explained, different devices may execute learning and prediction separately.

To be specific, the learning device 100 generates a learning model using Deep Tensor (registered trademark) that performs deep learning (DL) on graph-structured data with attendance record data (label: with sick leave) of an unwell person who took sick leave (suspension of work) and attendance record data (label: without sick leave) of a person who has not taken sick leave (suspension of work) as supervised data. Then, the learning device 100 uses the learning model to which learning findings are applied to implement inference for an accurate event (label) with respect to a new graph-structured data.

For example, the learning device 100 generates a plurality of pieces of learning data (supervised data) from time series data having a plurality of items and having a plurality of records corresponding to a calendar, each piece of learning data being a certain period of data, the certain period being composed of a plurality of unit periods, start times of the certain period of data being different from each other for the unit period, in which each piece of the certain period of data and a label corresponding to the start time thereof are paired. Then, the learning device 100 generates, from the generated learning data, tensor data in which a tensor is created with calendar information and the items having different dimensions. After that, the learning device 100 performs deep learning of a neural network and learning of a method of tensor decomposition with respect to a learning model in which the tensor data is subjected to the tensor decomposition as input tensor data, so as to be input to the neural network. In this manner, the learning device 100 generates a plurality of pieces of learning data from the attendance record data and generates a learning model to provide classification into “take sick leave” and “not take sick leave” based on the tensor data of each piece of learning data.

After that, the learning device 100 generates tensor data by similarly creating a tensor from the attendance record data of an employee who is to be determined and inputs the tensor data to the learned learning model. The learning device 100 outputs an output value representing prediction results whether the target employee “takes sick leave” or “not take sick leave.”

The following explains Deep Tensor. Deep Tensor is a deep learning with a tensor (graphic information) as input. Deep Tensor automatically extracts a partial graph structure that contributes to a determination, together with learning a neural network. This extraction processing is provided by learning parameters for tensor decomposition of input tensor data together with learning a neural network.

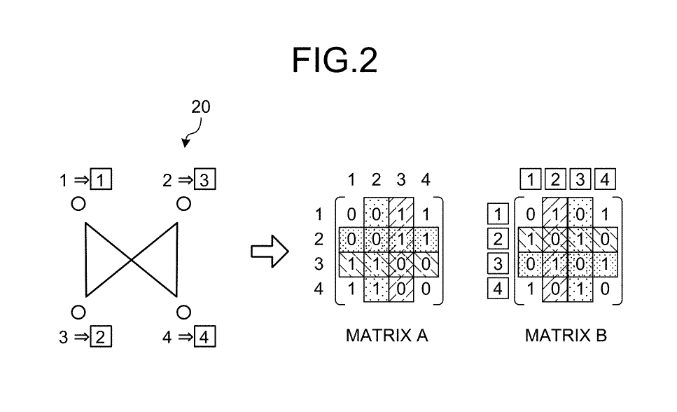

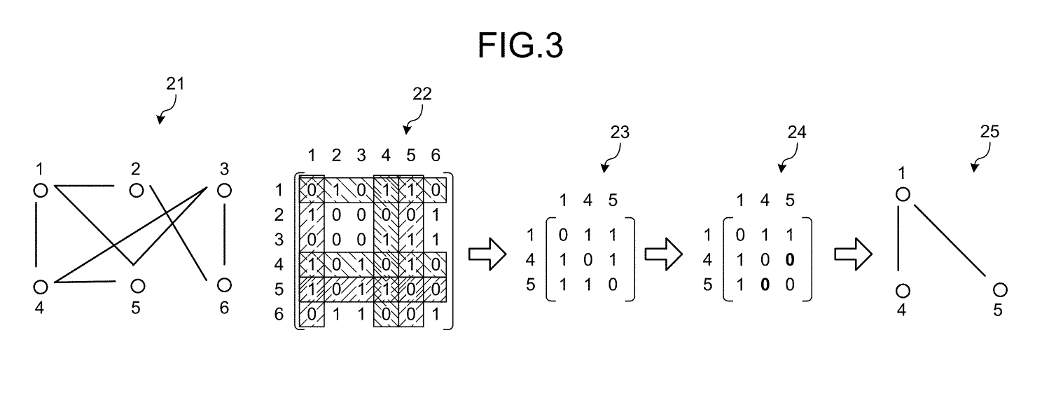

Next, the following explains a graph structure with reference to FIGS. 2 and 3. FIG. 2 is a diagram exemplifying a relation between a graph structure and a tensor. In a graph 20 of FIG. 2, four nodes are tied with an edge representing a relation between the nodes (for example, “a correlation factor is equal to or greater than a certain value”). It is indicated that the nodes that are not tied with the edge do not have the above-described relation. When the graph 20 is expressed with a second order tensor, that is, a matrix, a matrix representation based on numbers on the left side of the nodes is represented as “matrix A” and that based on numbers on the right side of the nodes (numbers surrounded with boxes) are represented as “matrix B,” for example. The components of each of these matrices are represented as “1” where nodes are tied (connected), and as “0” where nodes are not tied (not connected). In the following explanation, the above-described matrix is also referred to as the adjacency matrix. It is possible to create the “matrix B” by swapping the second row and the third row and swapping the second column the and third column of the “matrix A.” Deep Tensor performs processing ignoring the difference of the order by using this swap. That is, Deep Tensor ignores the ordinality of the “matrix A” and “matrix B” and treats the matrices as the same graph. The same processing is performed also for the third or higher order tensor.

FIG. 3 is a diagram exemplifying extraction of a partial graph structure. In a graph 21 of FIG. 3, six modes are tied with an edge. The graph 21 is represented as a matrix 22 by being expressed with a matrix (tensor). With respect to the matrix 22, it is possible to extract a partial graph structure by combining an operation to swap specific rows and specific columns, an operation to extract a specific row and a specific column, and an operation to replace a non-zero element with zero in an adjacency matrix. For example, extracting a matrix corresponding to “nodes 1, 4, 5” of the matrix 22 produces a matrix 23. Next, replacing a value between “nodes 4, 5” of the matrix 23 with zero produces a matrix 24. A partial graph structure corresponding to the matrix 24 produces a graph 25.

Such processing to extract a partial graph structure is implemented by a mathematical operation referred to as tensor decomposition. Tensor decomposition is an operation to approximate the input n-th order tensor with a product with the n-th or lower order tensor. For example, the input n-th order tensor is approximated with a product of the one n-th order tensor (referred to as a core tensor), and n tensors the order of which is lower than n-th (when n>2, normally the second order tensor, or matrix, is used). This decomposition is not unique, but any desired partial graph structure in the graph structure represented by the input data is able to be included in the core tensor.

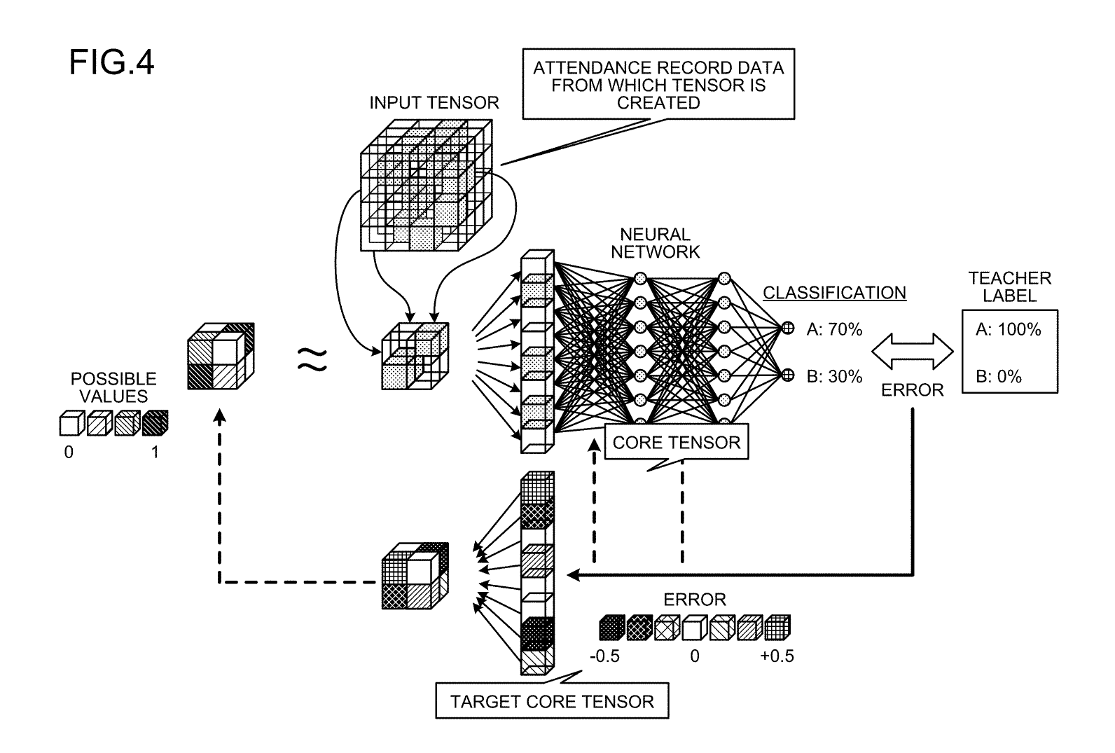

The following explains learning of Deep Tensor. FIG. 4 is a diagram for explaining a learning example of Deep Tensor. As illustrated in FIG. 4, the learning device 100 generates tensor data from attendance record data attached with a teacher label (label A) such as “with sick leave.” The learning device 100 performs tensor decomposition with the generated tensor data as an input tensor to generate a core tensor so as to analogize to a target core tensor generated for the first time at random. Then, the learning device 100 inputs the core tensor to the neural network (NN: Neural Network) to obtain classification results (label A: 70%, label B: 30%). After that, the learning device 100 calculates a classification error between the classification results (label A: 70%, label B: 30%) and the teacher label (label A: 100%, label B: 0%).

The learning device 100 executes learning of a prediction model using the expanded error propagation method obtained by expanding the error back-propagation method. That is, the learning device 100 corrects various kinds of parameters of NN so that the classification error becomes smaller as the classification error is propagated toward lower layers through an input layer, an intermediate layer, and an output layer included in the NN. Furthermore, the learning device 100 causes the classification error to be propagated to the target core tensor to correct the target core tensor so as to be closer to a partial graph structure that contributes to prediction, that is, a feature pattern representing a feature that a person who takes suspension of work or a feature pattern representing a feature that a person who has not taken sick leave has. This correction allows an optimized target core tensor to have a partial pattern that contributes to the prediction extracted thereto.

When a prediction is performed, an input tensor is converted to a core tensor (a partial pattern of the input tensor) by tensor decomposition and the core tensor is input to a neural network, and thereby prediction results are obtained. The tensor decomposition allows the core tensor to be converted so as to analogize to the target core tensor. That is, a core tensor having a partial pattern that contributes to prediction is extracted.

### Functional Configuration

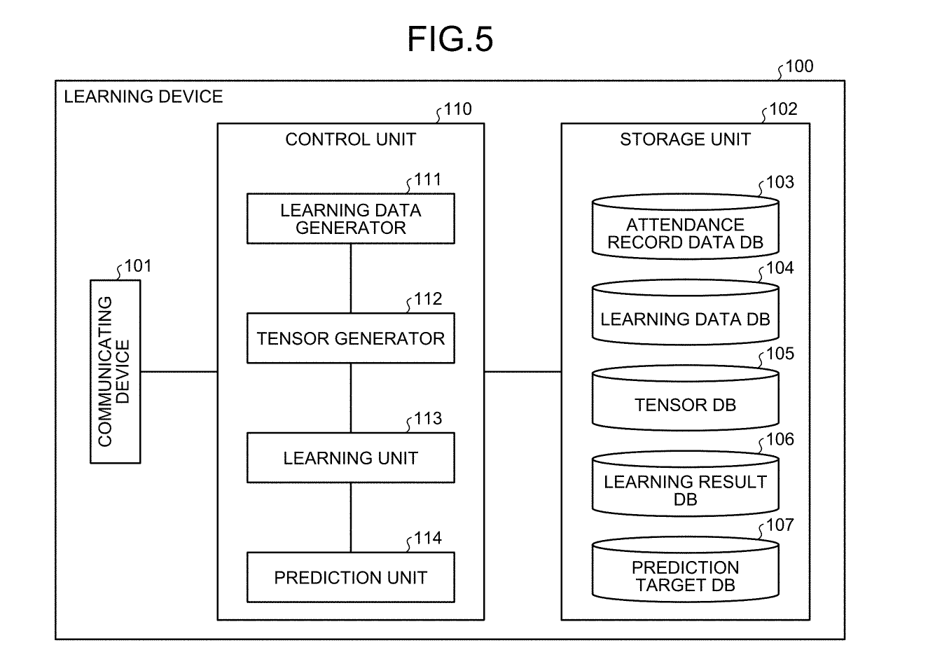

FIG. 5 is a functional block diagram illustrating a functional structure of the learning device 100 according to the first embodiment. As illustrated in FIG. 5, the learning device 100 includes a communicating unit 101, a storage unit 102, and a control unit 110.

The communicating unit 101 is a processing unit that controls communication with other devices, which provides a communication interface, for example. For example, the communicating unit 101 receives a process start instruction, attendance record data, and the like, from the terminal of an administrator. The communication unit 101 outputs learning results, prediction results of prediction target data, and the like, to the administrator terminal.

The storage unit 102 exemplifies a storage device that stores therein a computer program and data, such as a memory and a hard disk. This storage unit 102 stores therein an attendance record data DB 103, a learning data DB 104, a tensor DB 105, a learning result DB 106, and a prediction target DB 107.

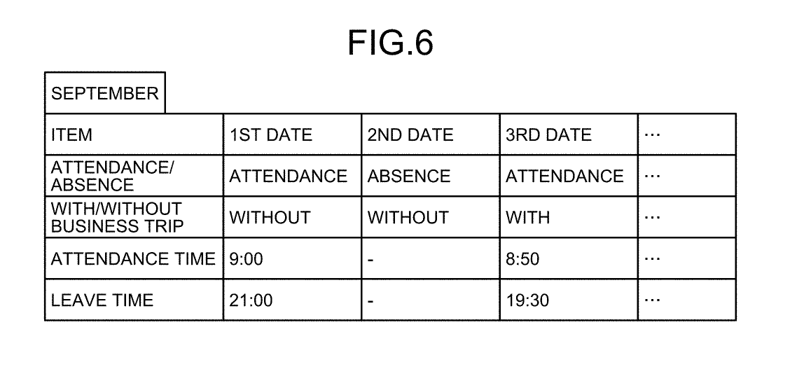

The attendance record data DB 103 is a database that stores therein attendance record data concerning the attendance of an employee or the like input by a user or the like, and exemplifies time series data. The attendance record data stored here is composed of a plurality of items and contains a plurality of records corresponding to the calendar. Furthermore, the attendance record data is made by data organization based on attendance records used in respective companies, and is able to be obtained from various kinds of well-known attendance management systems or the like. FIG. 6 is a diagram illustrating an example of attendance record data stored in the attendance record data DB 103. As illustrated in FIG. 6, the attendance record data is constituted of records on a daily basis for each month (-month) in accordance with a calendar, and each record stores therein daily attendance information with values of items such as “attendance/absence, with/without business trip, attendance time, and leave time” being associated with one another. The example of FIG. 6 indicates that an employee “on September 1, attended at 9:00 and left at 21:00, instead of taking a business trip.”

It is noted that to the classification item of attendance/absence, a value corresponding to any one of items such as coming to the office, sick leave (suspension of work), accumulated holiday, and paid holiday is set. For the item of with/without business trip, a value of with/without a business trip is set, and the value corresponding to with or without taking a business trip are stored therein. It is noted that the above-described values are able to be distinguished with numbers or the like. For example, it is possible to distinguish the values in such a manner as attendance=0, sick leave=1, accumulated holiday=2, and paid holiday=3, for example. It is noted that a record unit corresponding to the calendar of the attendance data record may be not only a daily unit but also a weekly or a monthly unit. Moreover, in accordance with a case where it is possible to take leave in an hourly unit, a value of hourly leave=4 may be set.

A learning data DB 104 is a database that stores therein learning data from which tensor is created. Specifically, the learning data DB 104 stores therein a plurality of pieces of learning data in which a certain period of data having a different start time in the attendance record data and a label corresponding to the start time are paired. For example, the learning data DB 104 stores therein “learning data a, label (without sick leave),” “learning data b, label (with sick leave),” and the like, as “data, label.” It is noted that the learning data will be explained later.

The tensor DB 105 is a database that stores therein a tensor (tensor data) generated from each piece of the learning data. This tensor DB 105 stores therein training data in which tensors and labels are associated with each other. For example, the tensor DB 105 stores therein “tensor data a, label (with sick leave),” “tensor data b, label (without sick leave),” and the like, as “tensor data, label.” It is noted that the label that the tensor DB 105 stores therein is a label that is associated with the learning data from which the tensor is generated.

It is noted that settings of record items and tensor data labels in the above-described learning data are merely examples, and not limited to values and labels such as “with sick leave” and “without sick leave.” It is also possible to use various types of values and labels such as “a person who takes suspension of work” and “a person who has not taken suspension of work,” and “with a suspension of work” and “without a suspension of work,” which are able to distinguish the existence of an unwell person.

The learning result DB 106 is a database that stores therein a learning result. For example, the learning result DB 106 stores a determination result (classification result) of learning data by the control unit 110, various parameters of NN and various parameters of Deep Tensor learned through machine learning or deep learning, and the like.

The prediction target DB 107 is a database that stores therein attendance record data of a target for which the existence of sick leave (suspension of work) is predicted using a learned prediction model. For example, the prediction target DB 107 stores therein attendance record data of a prediction target, tensor data generated from the attendance record data of the prediction target, and the like.

The control unit 110 is a processing unit that manages the whole processing of the learning device 100, and is a processor, for example. This control unit 110 includes a learning data generator 111, a tensor generator 112, a learning unit 113, and a prediction unit 114. It is noted that the learning data generator 111, the tensor generator 112, the learning unit 113, and the prediction unit 114 exemplify a process that is executed by an electronic circuit included in the processor or the like, or the processor or the like.

The learning data generator 111 is a processing unit that generates a plurality of pieces of learning data from pieces of attendance record data stored in the attendance record data DB 103, each piece of learning data being a certain period of data, the certain period being composed of a plurality of unit periods, start times of the certain period of data being different from each other for the unit period, in which each piece of the certain period of data and a label corresponding to the start time thereof are paired. Specifically, the learning data generator 111 samples data for a specified period from the attendance record data of one person, with overlapping allowed. For example, the learning data generator 111 extracts, from each piece of attendance record data, a plurality of pieces of data having different beginnings of periods (start times), and sets a label “with sick leave” when sick leave period (suspension of work period) exists within three months after the end time for each piece of data or a label “without sick leave” when sick leave period (suspension of work period) does not exist within three months after the end period therefor.

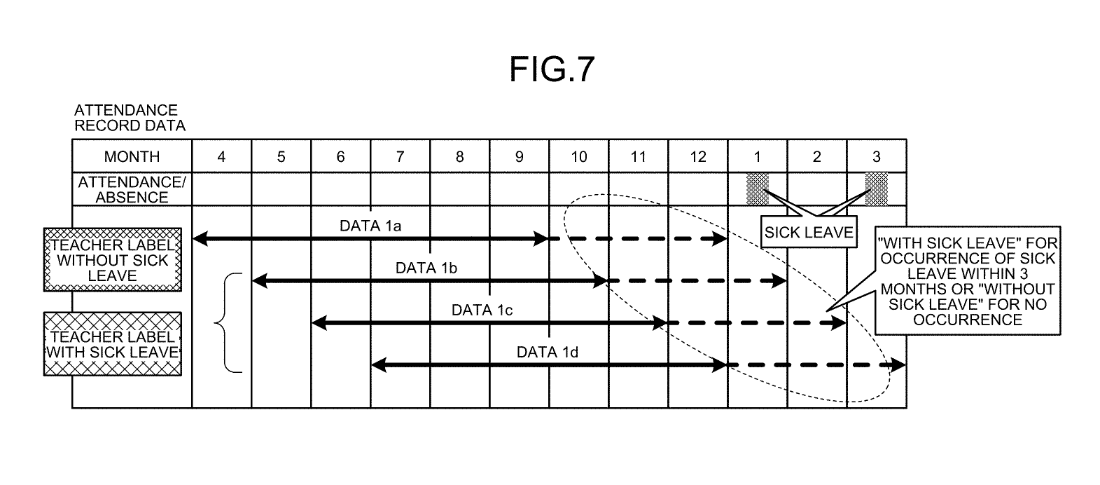

FIG. 7 is a diagram for explaining a generation example of learning data. FIG. 7 explains an example of generating four pieces of learning data from the attendance record data of one person, through sampling with attendance record data for six months as one sample, shifting the start time of each piece of attendance record data of one person by 30 days. As illustrated in FIG. 7, the learning data generator 111 extracts data la for six months from April to September, from one-year attendance record data from April to March. Then, the learning data generator 111 determines a label as “without sick leave” because “sick leave” has not occurred in October, November, and December, which are within three months from September. As a result, the learning data generator 111 stores “data 1a, label (without sick leave)” in the learning data DB 104.

Subsequently, the learning data generator 111 extracts data 1b for six months from May to October by shifting the start time by 30 days (one month) from April. Then, the learning data generator 111 determines the label as “with sick leave” because “sick leave” occurred in January out of November, December, and January, which are within three months from October. As a result, the learning data generator 111 stores “data 1b, label (with sick leave)” in the learning data DB 104.

Next, the learning data generator 111 extracts data 1c for six months from June to November by shifting the start time by 30 days (one month) from May. Then, the learning data generator 111 determines the label as “with sick leave” because “sick leave” occurred in January out of December, January, and February, which are within three months from November. As a result, the learning data generator 111 stores “data 1c, label (with sick leave)” in the learning data DB 104.

Finally, the learning data generator 111 extracts data 1d for six months from July to December by shifting the start time by 30 days (one month) from June. Then, the learning data generator 111 determines the label as “(with sick leave)” because “sickness” occurred in January and March out of January, February, and March, which are within three months from December. As a result, the learning data generator 111 stores “data 1d, label (with sick leave)” in the learning data DB 104.

In this manner, the learning data generator 111 is capable of generating maximum four samples of learning data from a one-year attendance record for one person. It is noted that the learning data generator 111 is capable of generating maximum 12 pieces of learning data from attendance record data of one person when sampling is performed with attendance record data for six months as one sample by shifting the start time by ten days.

The tensor generator 112 is a processing unit that generates tensor data in which a tensor is created from each piece of learning data. The tensor generator 112 creates a tensor with calendar information, and each of the items of “month, date, attendance/absence, with/without business trip, attendance time, and leave time” included in each piece of attendance record data as a dimension. The tensor generator 112 stores the created tensor (tensor data) associated with a label that is attached by the learning data generator 111 to the learning data from which the tensor is created, in the tensor DB 105. Learning is executed by Deep Tensor with the generated tensor data as input. It is noted that Deep Tensor, during learning, extracts a target core tensor that identifies a partial pattern of learning data having an influence on prediction, and executes the prediction based on the extracted target core tensor when the prediction is performed.

Specifically, the tensor generator 112 generates a tensor from learning data with items that are assumed to characterize tendency of taking sick leave, such as frequent business trips, long overtime, repeated sudden absences, absence without notice, frequent holiday works, and a combination of any of these items, as dimensions. For example, the tensor generator 112 generates a fourth order tensor of four dimensions using four elements of month, date, attendance/absence, and with/without business trip. When four months of data are used, an element count for month is “4,” an element count of date is “31” based on the fact that the maximum number of days of a month is 31, an element count of attendance/absence is “3” based on the fact that types of attendance/absence are coming to the office, leave, and holiday, an element count of with/without business trip is “2” based on the fact that business trip is done or not done. Thus, a tensor generated from learning data is a tensor of “4×31×3×2” and a value of an element corresponding to an item among attendance/absence and with/without business trips in the months and dates in the learning data is 1, and a value of an element not corresponding to any of those items is 0. Any desired item is selectable as a dimension for a tensor or is determinable based on the past event.

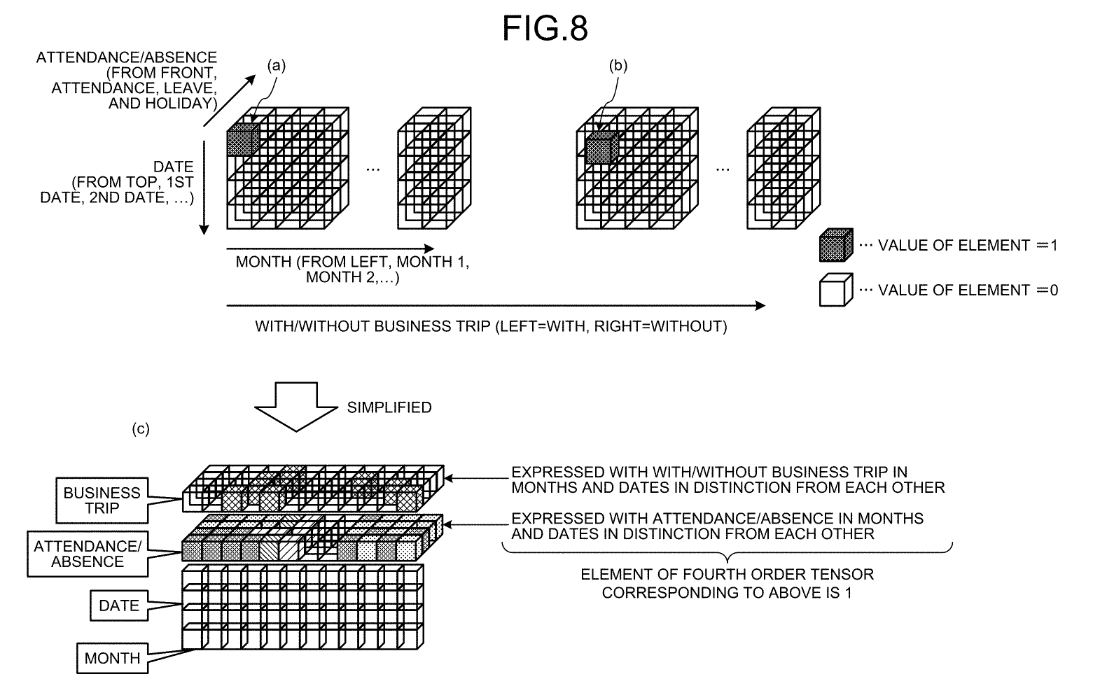

FIG. 8 is a diagram for explaining a specific example of creating a tensor. As illustrated in FIG. 8, a tensor generated by the tensor generator 112 represents data having horizontally months, vertically dates, attendance/absence in depth, a business trip from the left, and no business trip from the middle. Dates are represented in descending order with the first day as a top, and attendance/absence is represented with attendance, leave, and holiday in this order from the front side. For example, FIG. 8(a) represents an element of coming to the office and then taking a business trip on the first day of month 1, and FIG. 8(b) represents an element of taking a leave and not taking a business trip on the second day of month 1.

In the first embodiment, the above-described tensor is simplified to be described as in FIG. 8(c). That is, the tensor is expressed in a cube-shaped manner in which elements such as months, dates, attendance/absence, and with/without a business trip are stacked one another, with with/without a business trip in the months and dates expressed in distinction from each other, and with attendance/absence in the months and dates expressed in distinction from each other.

The learning unit 113 is a processing unit that performs deep learning of the neural network and learning of a method of tensor decomposition with respect to a learning model in which the tensor data is subjected to tensor decomposition as input tensor data, so as to be input to the neural network (NN). That is, the learning unit 113 executes learning of the learning model by Deep Tensor with the tensor data generated from each piece of the learning data and the label as input.

Specifically, similarly to the method explained in FIG. 4, the learning unit 113 extracts a core tensor from tensor data to be input (input tensor) to input the extracted core tensor to NN, and calculates an error (classification error) between a classification result from NN and a label attached to the input tensor. Then, the learning unit 113 executes, using the classification error, learning of the parameters of NN and optimization of the target core tensor. The learning unit 113, after completing the learning, stores various kinds of parameters as learning results in the learning result DB 106.

The prediction unit 114 is a processing unit that predicts, using the learning results, a label of data that is to be determined. Specifically, the prediction unit 114 reads out the various kinds of parameters from the learning result DB 106, and builds Deep Tensor including the neural network in which the various kinds of parameters are set, and the like. Then, the prediction unit 114 reads out the attendance record data of a prediction target from the prediction target DB 107 to create a tensor therefrom, and inputs the created tensor to Deep Tensor. After that, the prediction unit 114 outputs a prediction result indicating with or without sick leave. The prediction unit 114, then displays the prediction result on a display or transmits the prediction result to an administrator terminal. It is noted that the attendance record data of a prediction target may be input as it is or may be input with the data divided every six months.

Processing Flow

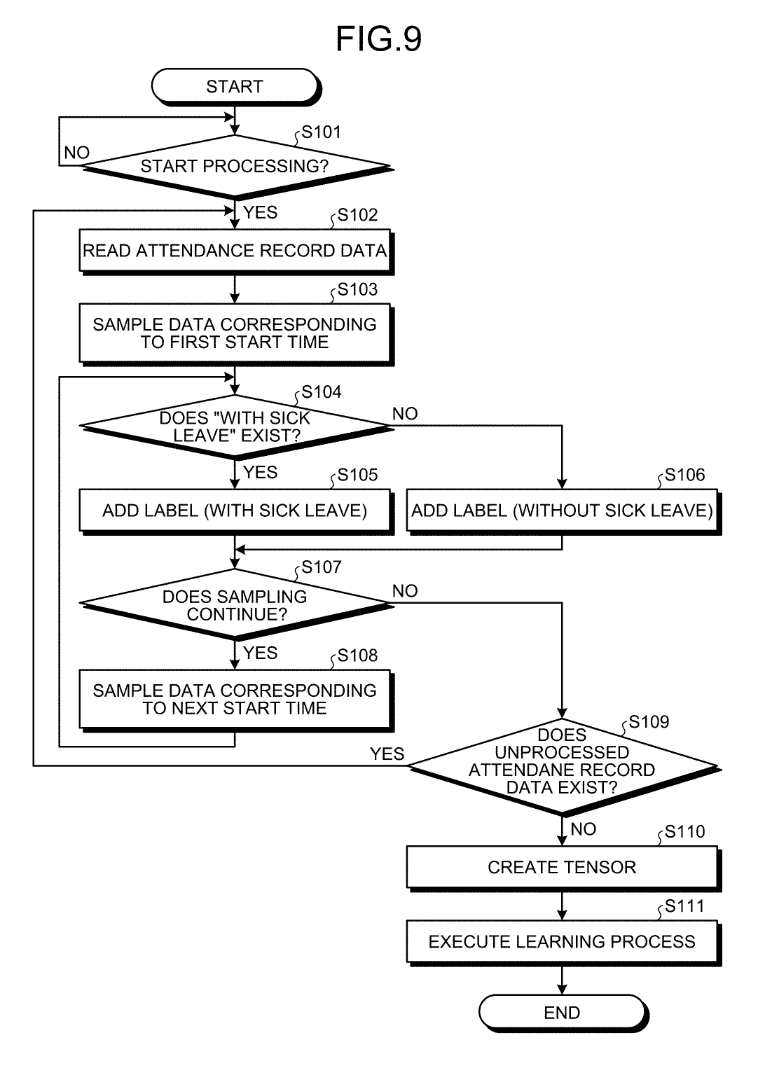

The following explains a flow of the learning process. FIG. 9 is a flowchart illustrating the flow of learning process. As illustrated in FIG. 9, when the process start is instructed (S101: Yes), the learning data generation unit 111 reads attendance record data from the attendance record data DB 103 (S102), and samples data corresponding to the first start time (S103).

Then, when data containing “sick leave” within three months is sampled (S104: Yes), the learning data generator 111 attaches a label of “with sick leave” to the sampled data (S105). By contrast, when data not containing “sick leave” within three months is sampled (S104: No), the learning data generator 111 attaches a label of “without sick leave” to the sampled data (S106).

When continuing sampling (S107: Yes), the learning data generator 111 samples data corresponding to the next start time (S108), and executes S104 and the subsequent steps. By contrast, when closing the sampling (S107: No), the learning data generator 111 determines whether there is any unprocessed attendance record data (S109).

When there is unprocessed attendance record data (S109: Yes), the learning data generator 111 repeats S102 and the subsequent steps to the following attendance record data. By contrast, when there is not any unprocessed attendance record data (S109: No), the tensor generator 112 executes creating a tensor from a piece of the learning data stored in the learning data DB 104 to create tensors (S110), and the learning unit 113 executes, using the tensors and labels stored in the tensor DB 105, learning process (S111).

### Effect

For an organization of 1,000 persons containing approximately 30 unwell persons, the number of samples for the unwell persons is no more than 30 when one sample is taken from attendance record data for each person of the organization. However, as described above, the learning device 100 according to the first embodiment is able to generate maximum 120 samples of learning data of the unwell persons by shifting the start time by 30 days. Furthermore, the learning device 100 is able to generate maximum 360 samples of learning data for the unwell persons by shifting the start time by ten days.

Thus, the learning device 100 is able to secure a sufficient number of samples for learning, thereby executing learning by Deep Tensor and improving the accuracy of learning. Moreover, in a case where an unwell condition prediction model is newly built, as opposed to using the learned model, for such a reason that a different item is processed in the attendance record data, even a small organization is able to build an unwell condition prediction model by applying the method according to the first embodiment.

### Comparison With General Machine Learning

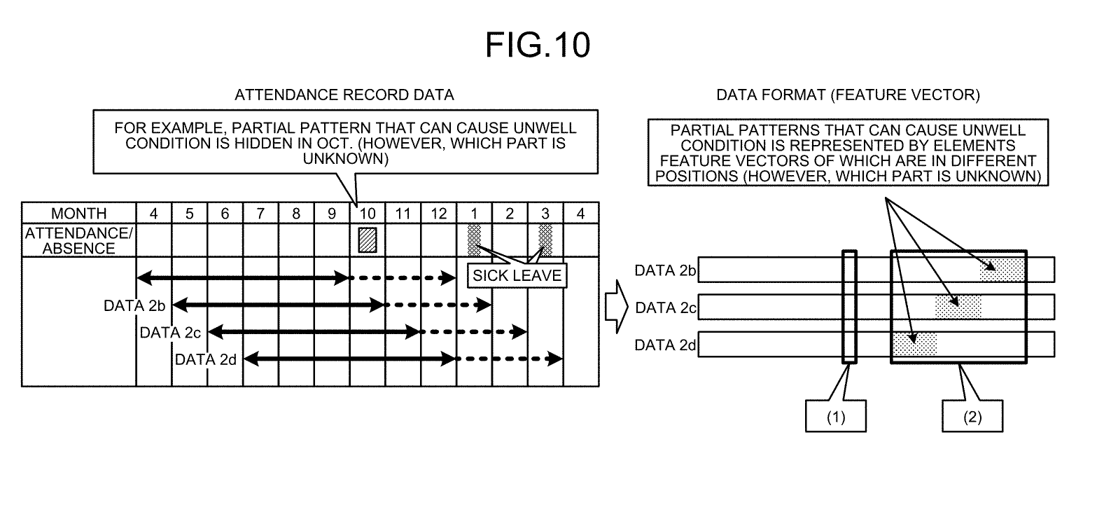

The following explains an example of increasing learning data in number by applying the method according to the first embodiment to general machine learning. FIG. 10 is a diagram for explaining a problem in a case where the method of the first embodiment is applied to general machine learning. FIG. 10 assume that there is a partial pattern that can cause an unwell condition hidden in a part of October of the attendance record data, yet the part not being specified. Under such a condition, as illustrated in FIG. 10, by shifting the start time by 30 days, data 2b, data 2c, and data 2d are extracted. These pieces of data belong to an unwell person (label: with sickness leave) because the period of each piece of data includes October.

In the general machine learning, elements the feature vectors of which are in the same position are learned to have the same attribute (FIG. 10(1)). However, data 2b, data 2c, and data 2d are different in the position of data in October. Thus, their partial patterns that can each cause an unwell condition are represented by elements the feature vectors of which are in different positions. That is, for the data generated by the sampling method of the first embodiment, data 2b, data 2c, and data 2d have respective partial patterns that are originally in different positions. In the general machine learning, elements having different positions are learned to have different attributes, and thus the effect of accuracy improvement brought by allowing duplication of data is not expectable.

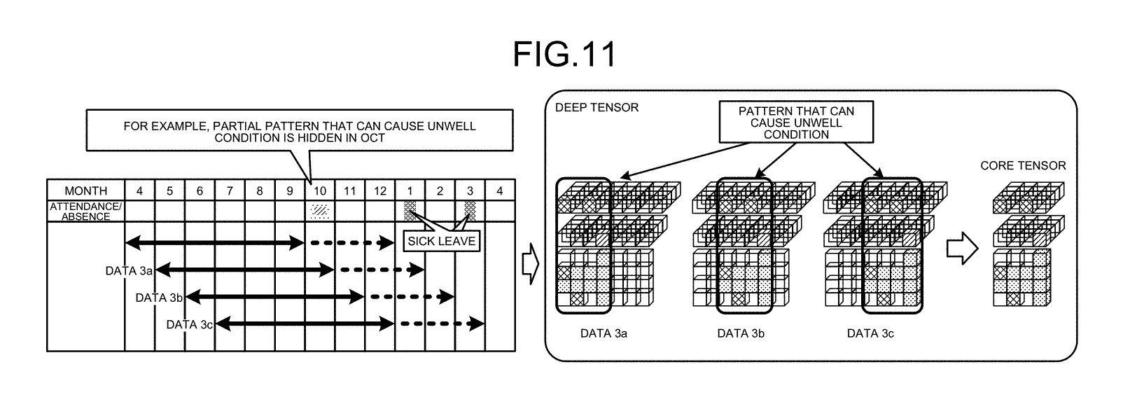

By contrast, the following explains an example using the method according to the first embodiment under the same condition. FIG. 11 is a diagram for explaining an example of applying the method of the first embodiment to Deep Tensor. As illustrated in FIG. 11, by shifting the start time by 30 days, data 3b, data 3c, and data 3d are extracted. These pieces of data belong to an unwell person (label: with sickness leave) because the period of each piece of data includes October. In learning by Deep Tensor, a common partial pattern that can cause an unwell condition is represented as a different partial structure on a tensor for a different piece of data. However, with a core tensor extracted through learning and a prediction model, a common partial pattern is represented. This makes it possible to recognize these pieces of data as data that can cause an unwell condition.

The learning device 100 according to the first embodiment thus generates a plurality of pieces of learning data by using Deep Tensor (core tensor) changing a range from which the original data is taken. As a result, it is possible to collect the number of pieces of data needed for learning, thereby improving the accuracy of learning.

### Simulation

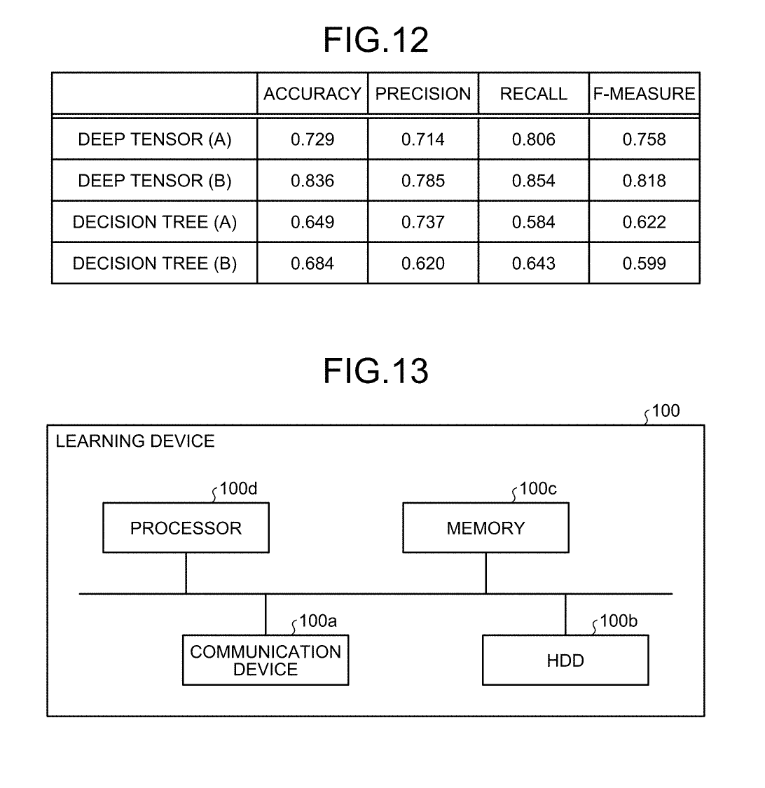

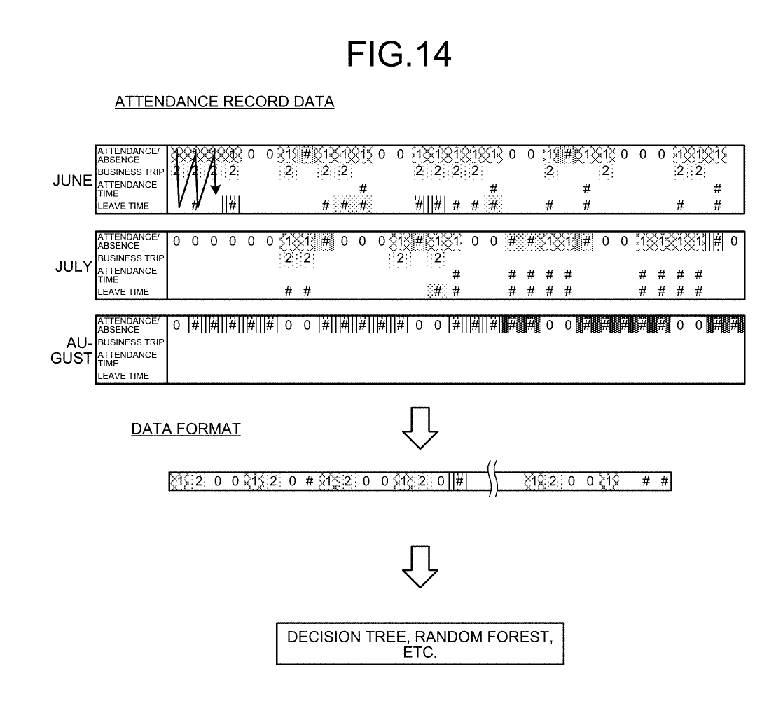

The following explains simulation results of Deep Tensor and the general machine learning. FIG. 12 is a diagram for explaining the effect. FIG. 12 is a diagram that provides results of 5-fold cross-validation in which attendance record data serving as test data is divided into five.

For each of Deep Tensor (A), Deep Tensor (B), decision tree (A), and decision tree (B), comparison is made to accuracy (accuracy rate), precision (relative factor), recall (recall factor), and F-measure, each serving as an index of the accuracy of learning. Deep Tensor (A) provides results of executing learning by Deep Tensor using 290 samples without increasing the number of samples. Deep Tensor (B) provides results of executing learning by Deep Tensor with the number of samples in the method of the first embodiment increased to 1,010. Decision tree (A) provides results of executing learning by decision tree using 290 samples without increasing samples. Decision tree (B) provides results of executing learning by decision tree with the number of samples in the method of the first embodiment increased to 1,010.

In the results of FIG. 12, it is determined that there is an effect when the learning results of (B) are greater than those of (A) in all the indexes. As illustrated in FIG. 12, all the indexes improved for Deep Tensor. By contrast, for the decision tree, the precision and the F-measure decreased. Thus, when the method of the first embodiment is applied to the decision tree, the improvement of precision is not expectable; however, for the learning device 100, the improvement of precision is expectable.

### [b] Second Embodiment

Although the embodiments of the present invention have been explained, the present invention may be implemented in various kinds of different aspects in addition to the above-described embodiments.

### Learning

The above-described learning process may be executed for any desired number of times. For example, the learning process may be executed using all pieces of training data, or may be executed for a certain number of times. Furthermore, as a method for calculating a classification error, a known calculation method such as the least square method may be employed, or a general calculation method used in NN may be employed. It is noted that learning weight or the like of a neural network by inputting tensor data to the neural network so as to be able to classify an event (for example, with sick leave and without sick leave), using learning data, corresponds to an example of a learning model.

While the explanation is made with attendance record data for six months as example data used for prediction, it is not limited thereto, but may be optionally changed to attendance record data for four months or the like. Moreover, while the explanation is made to the example in which a label is attached to attendance record data for six months depending on whether sickness leave (suspension of work) is taken within three months after the end time thereof, it is not limited thereto, but may be optionally changed to within two months or the like. The order of tensor data is not limited to fourth order, and tensor data below the fourth order may be generated, or tensor data of a fifth order or more may be generated.

Not only attendance record data but also any other format of data may be used as far as it provides conditions of employees or the like, such as coming to the office, leaving the office, and taking leave. In addition, the start time may be set at any desired point of attendance data, without being limited to the top of the attendance data.

### Neural Network

In the second embodiment, various kinds of neural networks such as RNN (Recurrent Neural Networks) and CNN (Convolutional Neural Network) may be used. For a method of learning, various kinds of known methods may be employed in addition to the error back-propagation method. A neural network has a multistage configuration including an input layer, an intermediate layer (hidden layer), and an output layer, for example, the layers each having a structure in which a plurality of nodes are tied with edges. Each of the layers has a function called “activation function,” each edge having “weight,” the value of each node being calculated based on the value of a node in the previous layer, the value of weight of a connection edge (weighting factor), and the activation function that the layer has. For a calculation method, various kinds of known methods are able to be employed.

Learning in a neural network refers to correcting parameters, that is, weight and bias so that the output layer has a correct value. In the error back-propagation method, “loss function” is determined that indicates how far the value of the output layer is away from a proper condition (desired condition) with respect to the neural network, and the weight and the bias are updated so that the loss function can be minimized using the steepest descent method and the like.

### System

Process procedures, control procedures, specific names, and information including various kinds of data and parameters represented in the above description and drawings may be optionally changed unless otherwise specified. The specific example, distribution, numeric values explained in the embodiments are merely examples, and may be optionally changed.

The components of the devices in the drawings have conceptual features, and do not necessarily have physical configurations as illustrated in the drawings. That is, specific forms of the distribution and integration of each device are not limited to those in the drawings. In other words, all or part of the devices may be functionally or physically distributed or integrated in any desired unit according to various kinds of loads and operating conditions. Moreover, all or any desired part of the processing functions of the devices are implemented by CPU and a computer program analyzed or executed by the CPU, or may be implemented as hardware with wired logic.

### Hardware

FIG. 13 is a diagram for explaining a hardware configuration example. As illustrated in FIG. 13, the learning device 100 includes a communication device 100a, a hard disc drive (HDD) 100b, a memory 100c, and a processor 100d. The units illustrated in FIG. 13 are connected through buses one another.

The communication device 100a is a network interface card or the like, which communicates with other servers. The HDD 100b stores therein a computer program and a database that operate the functions illustrated in FIG. 5.

The processor 100d reads out from the HDD 100b or the like to develop in the memory 100c a computer program that executes the same processing as that executed by the processing units illustrated in FIG. 5, so as to operate the process that executes the functions explained in FIG. 5 and the like. That is, the process executes the same functions as those of the processing units included in the learning device 100. Specifically, the processor 100d reads out from the HDD 100b or the like the computer program that has the same functions as those of the learning data generator 111, the tensor generator 112, the learning unit 113, the prediction unit 114, and the like. Then the processor 100d executes the process that executes the same processing as that executed by the learning data generator 111, the tensor generator 112, the learning unit 113, the prediction unit 114, and the like.

In this manner, the learning device 100 operates as an information processing device that executes a learning method by reading out to execute the computer program. Moreover, the learning device 100 is capable of implementing the same functions as those described in the above-described embodiments by allowing a media reader to read out the computer program from a recording medium to execute the read computer program. It is noted that the computer program referred to in other embodiments than the above-described embodiments is not limited to being executed by the learning device 100. For example, it is possible to apply the present invention similarly when another computer or server executes the computer program or these computer and server execute the computer program in cooperation with one another.

This computer program is distributable via a network such as the Internet. Furthermore, this computer program may be stored in a computer-readable recording medium such as a hard disc, a flexible disc (FD), a compact disc read-only memory (CD-ROM), a magneto-optical disk (MO), or a digital versatile disc (DVD), and may be executed by being read out from the recording medium.

According to one embodiment, it is possible to improve the accuracy of learning.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention.

Although the embodiments of the present invention have been described in detail, it should be understood that the various changes, substitutions, and alterations could be made hereto without departing from the spirit and scope of the invention.

What is claimed is:

1. A non-transitory computer-readable recording medium storing therein a machine learning program that causes a computer to execute a process comprising:
generating pieces of learning data based on time series data including a plurality of items and including a plurality of records corresponding to a calendar, each of the pieces of learning data being learning data of a certain period, the certain period being composed of a plurality of unit periods, start times of the certain period of each of the pieces of learning data being different from each other for the unit period, in which each of the pieces of the learning data and a label corresponding to the start time are paired;
generating, based on the generated learning data, tensor data in which a tensor is created with calendar information and the plurality of items having different dimensions; and
performing deep learning of a neural network and learning of a method of tensor decomposition with respect to a learning model in which the tensor data is subjected to the tensor decomposition as input tensor data to be inputted to the neural network.

2. The non-transitory computer-readable recording medium according to claim 1, wherein the process further includes:
extracting, from the time series data, the pieces of the certain period of data having the start times being shifted by a certain number of days; and
generating a plurality of pieces of learning data in which extracted each piece of the certain period of data and a label corresponding to the certain period of data are paired.

3. The non-transitory computer-readable recording medium according to claim 1, wherein the process further includes:
extracting, from attendance record data having items of months, dates, attendance/absence, and with/without business trip, a plurality of pieces of the certain period of data having the start times being different from each other;
to each piece of the certain period of data, when a sick leave period exists within a certain number of days after the end time of the piece of the certain period of data, setting with sick leave as a label, and when no sick leave period exists within a certain number of days after the end time of the piece of the certain period of data, setting without sick leave as a label; and
generating a plurality of pieces of learning data in which each piece of the certain period of data and the label set to the data according to the with sick leave or the without sick leave are paired.

4. A machine learning method comprising:
generating pieces of learning data based on time series data including a plurality of items and including a plurality of records corresponding to a calendar, each of the pieces of learning data being learning data of a certain period, the certain period being composed of a plurality of unit periods, start times of the certain period of each of the pieces of learning data being different from each other for the unit period, in which each of the pieces of the learning data and a label corresponding to the start time are paired;
generating, based on the generated learning data, tensor data in which a tensor is created with calendar information and the plurality of items having different dimensions; and
performing, by a processor, deep learning of a neural network and learning of a method of tensor decomposition with respect to a learning model in which the tensor data is subjected to the tensor decomposition as input tensor data to be inputted to the neural network.

5. A machine learning device comprising:
a processor configured to:
generate pieces of learning data based on time series data including a plurality of items and including a plurality of records corresponding to a calendar, each of the pieces of learning data being learning data of a certain period, the certain period being composed of a plurality of unit periods, start times of the certain period of each of the pieces of learning data being different from each other for the unit period, in which each of the pieces of learning data and a label corresponding to the start time are paired;
generate, based on the generated learning data, tensor data in which a tensor is created with calendar information and the plurality of items having different dimensions; and
perform deep learning of a neural network and learning of a method of tensor decomposition with respect to a learning model in which the tensor data is subjected to the tensor decomposition as input tensor data to be inputted to the neural network.
